(19) United States
(12) Patent Application Publication
(10) Pub. No.: US 2018/0288575 A1
(43) Pub. Date: Oct. 4, 2018

(54) TRACKING SYSTEM

(71) Applicant: Mastercard International Incorporated, Purchase, NY (US)

(72) Inventors: Dinesh Kumar Lal, Gurgaon (IN); Ashutosh Gupta, Varanasi (IN)

(73) Assignee: Mastercard International Incorporated, Purchase, NY (US)

(21) Appl. No.: 15/939,447

(22) Filed: Mar. 29, 2018

(30) Foreign Application Priority Data
Apr. 3, 2017 (SG) 10201702742Q

(51) Int. Cl. H04W 4/029; H04W 4/02; G06Q 20/32; G06Q 20/10; G06Q 20/12; G06Q 20/36

(52) U.S. Cl. CPC H04W 4/029; H04W 4/025; G06Q 20/36; G06Q 20/102; G06Q 20/12; G06Q 20/3224

(57) ABSTRACT

A tracking system, the system including one or more electronic processors, in communication with non-transitory computer readable data storage, which are configured to track a first device by receiving, from a second device, first message data representing a notification that the first device is missing; retrieving, from the data storage, account information associated with the first device; sending, to a payment processing system, second message data representing a tracking request; receiving, from the payment processing system, information associated with a location of the first device; determining, at a tracking server, location of the first device; and sending, to the second device, third message data representing location of the first device to the second device.

### CROSS-REFERENCE TO RELATED APPLICATIONS

This application claims the priority benefit of Singapore Application Serial No. 10201702742Q filed Apr. 3, 2017, which is incorporated herein by reference in its entirety.

### TECHNICAL FILED

### Field

The present disclosure relates to a tracking system and to a tracking method.

### Background

Mobile computer devices such as smart phones, tablets, laptops, wearables and smart devices have been rapidly gaining popularity. As the Internet advances, particularly in terms of technology, speed and global accessibility, internet-enabled mobile computer devices have increasingly become an essential part of a consumer's life.

Additionally, the push for the adoption of the “Internet of Things” has resulted in an increase of “smart” devices, cars and home automation devices in the consumer market. A survey conducted in 2014 showed that each user uses an average of three devices in countries such as UK, Australia, Canada and United States of America with the trend expecting to increase.

An increased reliance on mobile computer devices results in a huge inconvenience to the user if they go missing. Users may not be able to recover important information such as secure documents or time-sensitive work data from devices. In addition, secure information such as payment credentials may be fraudulently obtained and used maliciously, for example to effect fraudulent transactions or for identity theft.

Users, especially those with more than one mobile computer device, may find it difficult to keep track of multiple devices which may result in them misplacing a device. Additionally, mobile computer devices are frequently targeted by thieves as they may be expensive and relatively easy to conceal and transport.

It is generally desirable to overcome or ameliorate one or more of the above described difficulties, or to at least provide a useful alternative.

### SUMMARY OF INVENTION

In accordance with embodiments of the present disclosure, there is provided a tracking system, the system including one or more electronic processors, in communication with non-transitory computer readable data storage, which are configured to track a first device by:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with location of the first device;
(e) determining, at a tracking server, location of the first device; and
(f) sending, to the second device, third message data representing location of the first device to the second device.

In accordance with some embodiments, there is also provided a tracking method, performed by one or more electronic processors configured to track a first device by:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with location of the first device;
(e) determining, at a tracking server, location of the first device; and
(f) sending, to the second device, third message data representing location of the first device to the second device.

In accordance with some embodiments, there is also provided a non-transitory computer readable storage medium embodying thereon a program of computer readable instructions which, when executed by one or more processors of a tracking system in communication with a plurality of devices, cause the tracking system to track a first device, the method embodying the steps of:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with location of the first device;
(e) determining, at a tracking server, location of the first device; and
(f) sending, to the second device, third message data representing location of the first device to the second device.

In accordance with some embodiments, there is also provided a tracker server, the server including one or more electronic processors which are configured to track a first device by:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with location of the first device;
(e) determining, at the tracking server, location of the first device; and
(f) sending, to the second device, third message data representing location of the first device to the second device.

### BRIEF DESCRIPTION OF THE DRAWINGS

Embodiments of the present disclosure are hereafter described, by way of non-limiting example only, with reference to the accompanying drawings, in which:

FIG. 1 is a schematic diagram of a system for and a method for tracking a device;

FIG. 2 is a schematic diagram showing components of a mobile computer device of the system shown in FIG. 1;

FIG. 3 is a schematic diagram showing components of an exemplary server of the system shown in FIG. 1;

FIG. 4 is a flowchart diagram showing the steps of tracking a device being executed by the tracker server of the system shown in FIG. 1;

FIG. 5 is a flowchart diagram showing interoperation of the components of the system for tracking a device; and

FIG. 6 is a flowchart diagram showing the interoperation of the components of the system for creating an account to track a device.

### DETAILED DESCRIPTION OF EMBODIMENTS OF THE INVENTION

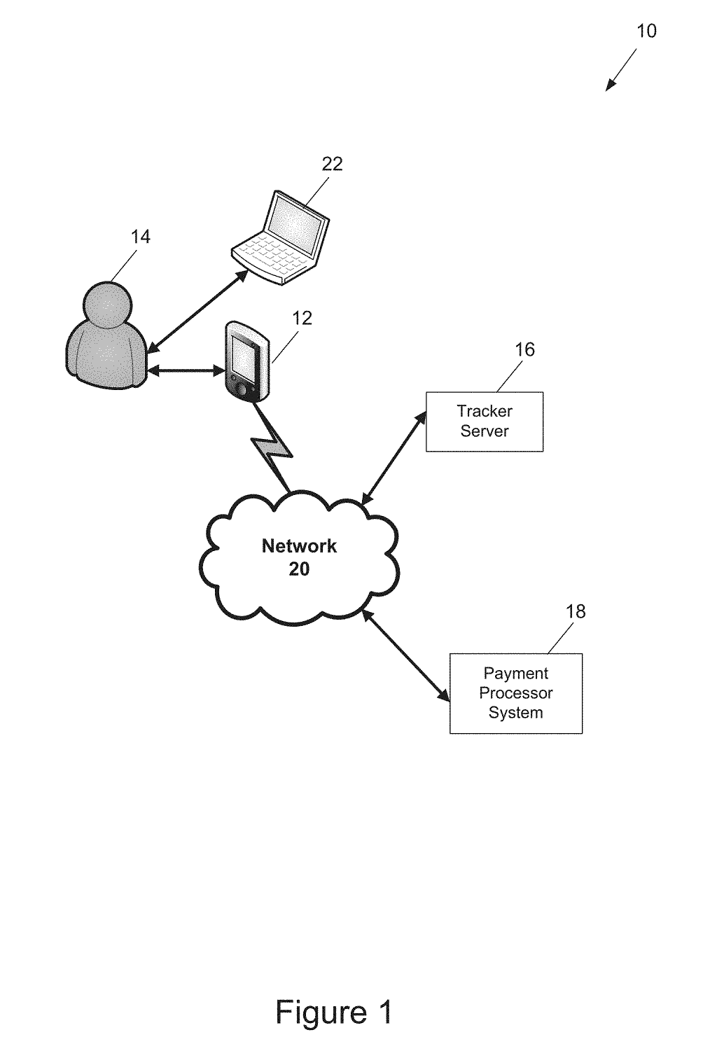

The exemplary system 10 shown in FIG. 1 allows a device to be tracked. The system 10 comprises one or more of the following:
(a) a first mobile computer device 12;
(b) a second mobile computer device 22;
(c) a user 14;
(d) a tracker server 16; and
(e) a payment processing system 18.

The components of system 10 are in communication via the network 20. The communication network 20 may comprise the Internet, telecommunications networks and/or local area networks.

The system 10 makes tracking devices simpler, faster and more convenient.

### Mobile Computer Device 12

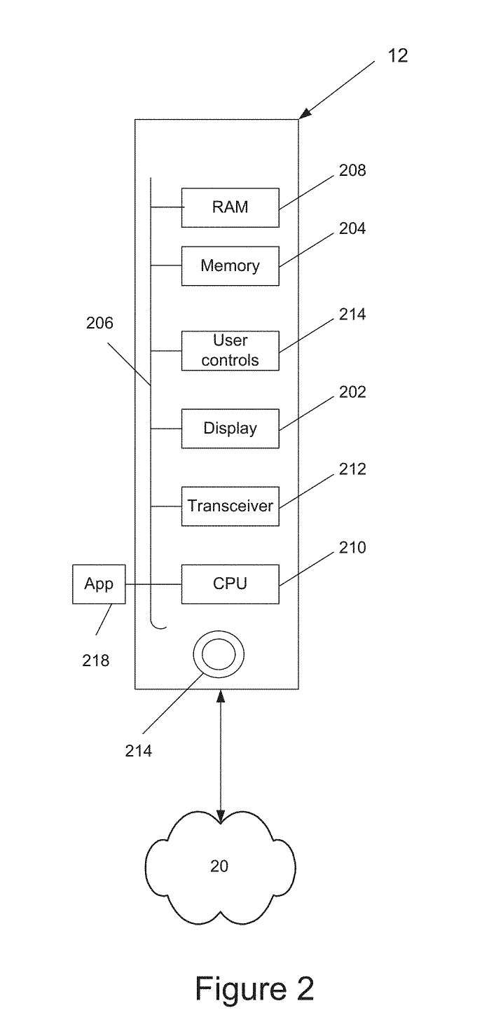

FIG. 2 is a block diagram showing an exemplary mobile computer device 12 in which embodiments of the invention may be practiced. The mobile computer device 12 may be a mobile computer device such as a smart phone, personal data assistant (PDA), palm-top computer, multimedia Internet enabled cellular telephone, laptop, tablet computer or wearable device.

For ease of description, the mobile computer device 12 is described below, by way of non-limiting example, with reference to a mobile computer device in the form of an iPhone™ manufactured by Apple™, Inc., or one manufactured by LGTM, HTC™ or Samsung™, for example.

As shown, the mobile computer device 12 comprises the following components in electronic communication via a bus 206:
(a) a display 202;
(b) non-volatile (non-transitory) memory 204;
(c) random access memory (“RAM”) 208;
(d) N processing components 210;
(e) a transceiver component 212 that comprises N transceivers; and
(f) user controls 214.

Although the components depicted in FIG. 2 represent physical components, FIG. 2 is not intended to be a hardware diagram. Thus, many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 202 generally operates to provide a presentation of content to a user, and may be realized by any of a variety of displays (e.g., CRT, LCD, HDMI, micro-projector and OLED displays).

In general, the non-volatile data storage 204 (also referred to as non-volatile memory) functions to store (e.g., persistently store) data and executable code.

In some embodiments for example, the non-volatile memory 204 comprises bootloader code, modem software, operating system code, file system code, and code to facilitate the implementation components, well known to those of ordinary skill in the art, which are not depicted nor described for simplicity.

In many implementations, the non-volatile memory 204 is realized by flash memory (e.g., NAND or ONENAND memory), but it is certainly contemplated that other memory types may be utilized as well. Although it may be possible to execute the code from the non-volatile memory 204, the executable code in the non-volatile memory 204 is typically loaded into RAM 208 and executed by one or more of the N processing components 210.

The N processing components 210 in connection with RAM 208 generally operate to execute the instructions stored in non-volatile memory 204. As one of ordinarily skill in the art will appreciate, the N processing components 210 may comprise a video processor, modem processor, DSP, graphics processing unit (GPU), and other processing components.

The transceiver component 212 comprises N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The transceiver component 212 is also adapted to effect contactless payments. For example, the transceiver component 212 is able to effect contactless payment using Near-Field Communications (NFC) according to the EMV standard. Digital payment methods based on the EMV standard may comprise Apple Pay™, or MasterPass™, for example.

It should be recognized that FIG. 2 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 204. Non-transitory computer-readable medium 204 comprises both computer storage medium and communication medium comprising any medium that facilitates transfer of a computer program from one place to another. A storage medium may be any available medium that can be accessed by a computer.

### Tracker Server 16

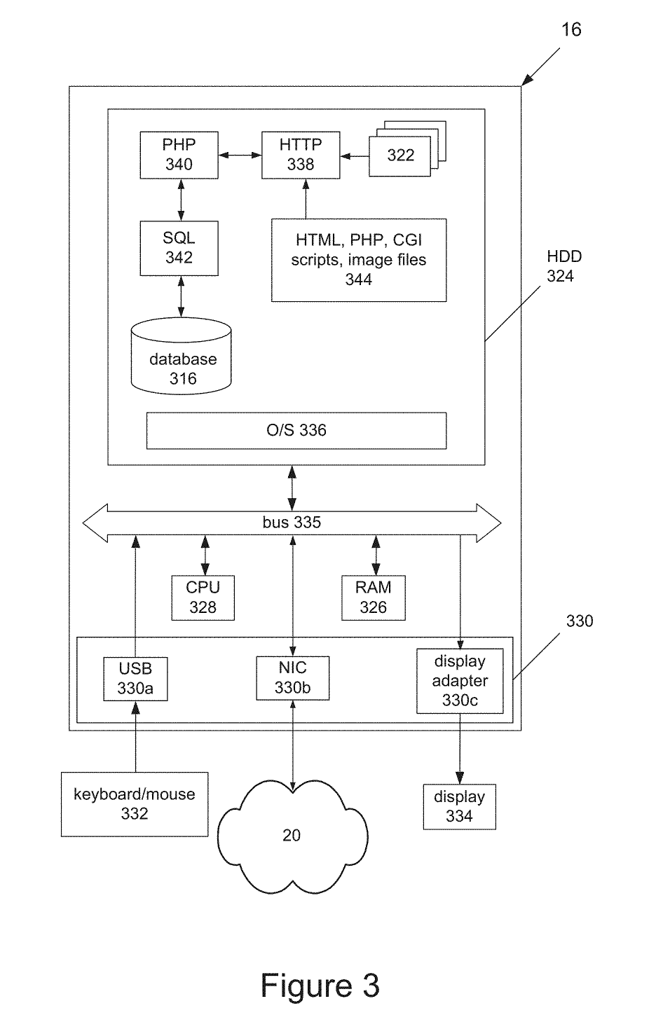

As shown in FIG. 3, the tracker server 16 may comprise a server 16. In some embodiments, the system may comprise multiple servers in communication with each other, for example over a local area network or a wide-area network such as the Internet. As described in the preceding section, the tracker server 16 is able to communicate with other components of the system 10 over the wireless communications network 20 using standard communication protocols.

The components of the tracker server 16 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs) or field programmable gate arrays.

In the example shown in FIG. 3, the tracker server 16 is a commercially available server computer system based on a 32 bit or a 64 bit Intel architecture, and the processes and/or methods executed or performed by the tracker server 16 are implemented in the form of programming instructions of one or more software components or modules 322 stored on non-volatile (e.g., hard disk) computer-readable storage 324 associated with the tracker server 16. At least parts of the software modules 322 could alternatively be implemented as one or more dedicated hardware components, such as application-specific integrated circuits (ASICs) and/or field programmable gate arrays (FPGAs).

The tracker server 16 comprises at least one or more of the following standard, commercially available, computer components, all interconnected by a bus 335:
(a) random access memory (RAM) 326;
(b) at least one computer processor 328, and
(c) external computer interfaces 330:
   (i) universal serial bus (USB) interfaces 330a (at least one of which is connected to one or more user-interface devices, such as a keyboard, a pointing device (e.g., a mouse 332 or touchpad),
   (ii) a network interface connector (NIC) 330b which connects the computer system 300 to a data communications network, such as the wireless communications network 20; and
   (iii) a display adapter 330c, which is connected to a display device 334 such as a liquid-crystal display (LCD) panel device.

The tracker server 16 comprises a plurality of standard software modules, including:
(a) an operating system (OS) 336 (e.g., Linux or Microsoft Windows);
(b) web server software 338 (e.g., Apache, available at http://www.apache.org);
(c) scripting language modules 340 (e.g., personal home page or PHP, available at http://www.php.net, or Microsoft ASP); and
(d) structured query language (SQL) modules 342 (e.g., MySQL, available from http://www.mysql.com), which allow data to be stored in and retrieved/accessed from an SQL database 316.

Advantageously, the database 316 forms part of the computer readable data storage 324. Alternatively, the database 316 is located remote from the server 16 shown in FIG. 3.

Together, the web server 338, scripting language 340, and SQL modules 342 provide the tracker server 16 with the general ability to allow the other components of the system 10 to communicate with the tracker server 16 and in particular to provide data to and receive data from the database 316. It will be understood by those skilled in the art that the specific functionality provided by the tracker server 16 to such users is provided by scripts accessible by the web server 338, including the one or more software modules 322 implementing the processes performed by the tracker server 16, and also any other scripts and supporting data 344, including markup language (e.g., HTML, XML) scripts, PHP (or ASP), and/or CGI scripts, image files, style sheets, and the like.

The boundaries between the modules and components in the software modules 322 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the tracker server 16 may be executed by a module (of software modules 322) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The tracker server 16 normally processes information according to a program (a list of internally stored instructions such as a particular application program and/or an operating system) and produces resultant output information via input/output (I/O) devices 330. A computer process typically comprises an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Payment Processing System 18

The payment processing system 18 is able to communicate with the tracker server 16 through standard communication protocols provided for by communications network 20, in order to receive requests to track transactions originating from a mobile computer device 12, process such requests, and convey responses back to the tracker server 16.

For example, the payment processing system 18 may comprise an acquirer system (which may in turn comprise a core banking system in communication with an acquirer processor system), a payment network (such as Mastercard, Visa or China Unionpay) and an issuer system (which may comprise a core banking system and an issuer processor system). In some cases, the acquirer and issuer may be the same entity, for example if the payment network is a three-party payment network (such as American Express or Discover) or other closed-loop payment system.

The payment processing system 18 may receive the payment authorization request via the acquirer system, which routes the request via the payment network to the issuer system in a manner known in the art. The request may be formatted according to the ISO 8583 standard, for example, and may comprise a primary account number (PAN) of the payment instrument being used for the transaction, a merchant identifier (MID), and an amount of the transaction, as well as other transaction-related information as will be known by those skilled in the art. The issuer system receives the request, applies authorization logic to approve or decline the request, and sends an authorization response (approve or decline, optionally with a code indicating the reason for the decline) back to the acquirer system via the payment network in known fashion. The acquirer system then communicates the authorization response to the tracker server 16.

Alternatively, in some embodiments, the payment processing system 18 may receive the payment authorization request via the issuer system, which approves or declines the request (which again may be in ISO 8583 format, and comprise a PAN, MID, transaction amount etc.) and sends a response directly back to the tracker server 16.

In addition to processing requests for payment in which funds are actually transferred from the cardholder's account (maintained in the issuer's core banking system) to the merchant's account (maintained in the acquirer's core banking system), the payment processing system 18 may process a pre-authorization (or “pre-auth”) request, in which funds are not transferred on approval of the request, but are instead placed on hold. The pre-auth can later be completed, for example by the merchant server 16 or the tracker server 16, in order to release the funds. Alternatively, the pre-auth can be cancelled, thus effectively cancelling the transaction.

The operational steps for embodiments of the invention are described in further detail below.

### Tracking Account Registration Process 400

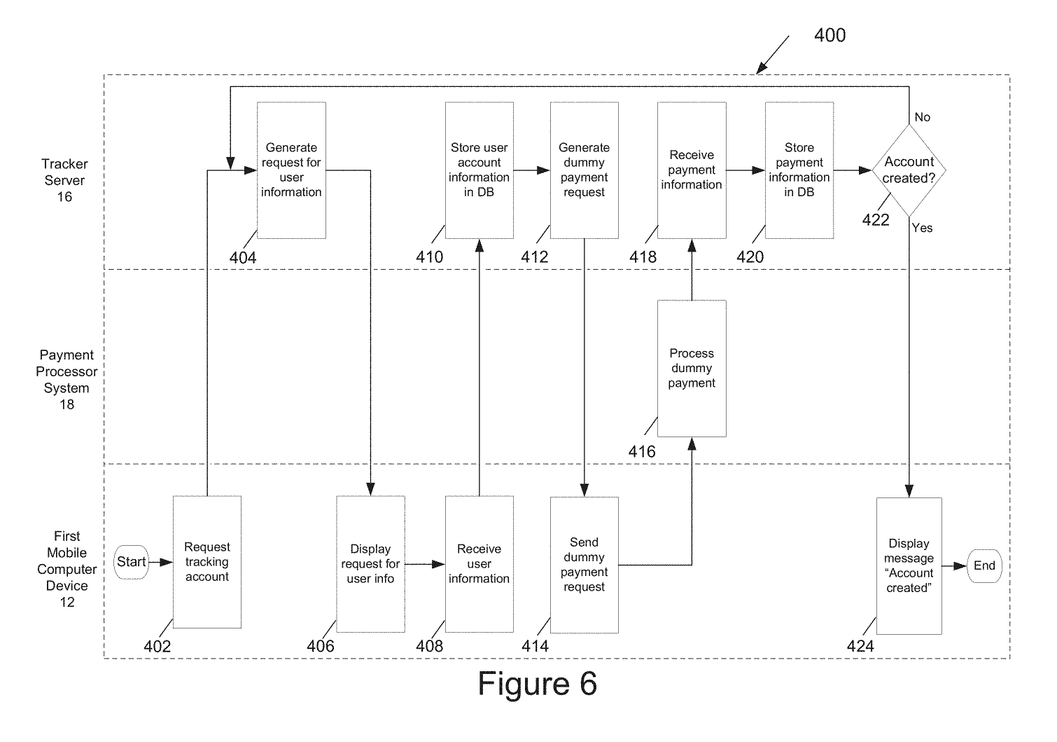

The interoperation of the components of system 10 is hereafter described by way of non-limiting example, with reference to the tracking account registration process 400 being executed on system 10 as shown in FIG. 6.

A user 14 who wants to register a tracking account for his or her mobile computer device 12 initiates the registration process 400 from the mobile computer device 12. The user 14 may sign up for a tracking account using the mobile computer device 12 in various ways, for example a mobile application or software program or using an internet browser accessing a website hosted by a tracker system 16. These systems are known in the art and as such will not be described in further detail. This embodiment of the invention requires the user to have access to the internet at least once in order to initiate and complete the registration for the tracking account.

At step 402, the mobile computer device 12 sends a request to create a tracking account to the tracker server 16. At step 404, the tracker server 16 retrieves from database 316, user information required for creating a tracking account. The tracker server 16 then sends a request for user information to the mobile computer device 12. The request for user information may comprise one or more of the following:
(a) personal information (e.g. full name, address);
(b) device information (e.g. make and model of device, device's connectivity features);
(c) device's payment capabilities (e.g. near field communication (NFC) payment protocols); or
(d) user's payment credentials (e.g. digital wallet account details, payment card information).

The request may also comprise device specific information or user authorisation to access information from the device which may comprise one or more of the following:
(a) internet protocol (IP) address;
(b) media access control (MAC) address;
(c) global positioning system (GPS) signals;
(d) network communication signals;
(e) subscriber identity module (SIM); and
(f) cellular network identifier.

At step 406, the mobile computer device 12 receives the request from the tracker server 16 and generates on display 202 the requested user information for user input. The user input may be a fillable form. At step 408, the mobile computer device 12 receives user input representing requested user information. The mobile computer device 12 then generates and sends said user information to the tracker server 16.

At step 410, the tracker server 16 receives the user information and stores it in data storage 316. At step 412, the tracker server 16 generates a dummy payment request and sends it to the mobile computer device 12. At step 414, the mobile computer device 12 receives the dummy payment transaction request and is redirected to a dummy merchant website or application. The mobile computer device 12 generates and sends a dummy payment transaction such as a pre-authorization request or a low-value (e.g., $0.01) transaction request to the payment processing system 18.

At step 416, the payment processing system 18 processes the dummy payment transaction request and sends the dummy payment authorization response information back to the tracker server 16. At step 418, the tracker server 16 receives the dummy payment authorization response information, which may comprise device specific information, and in step 420 saves the data in data storage 316.

At step 422, the tracker server determines if it has all the information required to create the tracking account and if so, creates the tracking account. If the tracker server 16 is successful in creating the account, a message is sent to the mobile computer device 12. At step 424, the mobile computer device 12 generates on display 202, a message representing successful creation of the tracking account.

The user 14 may have more than one mobile computer device which they would like to track. To do so, the user 14 may initiate the registration process 400 from the other device and repeat the process as described by the steps above.

### Device Tracking Process 500

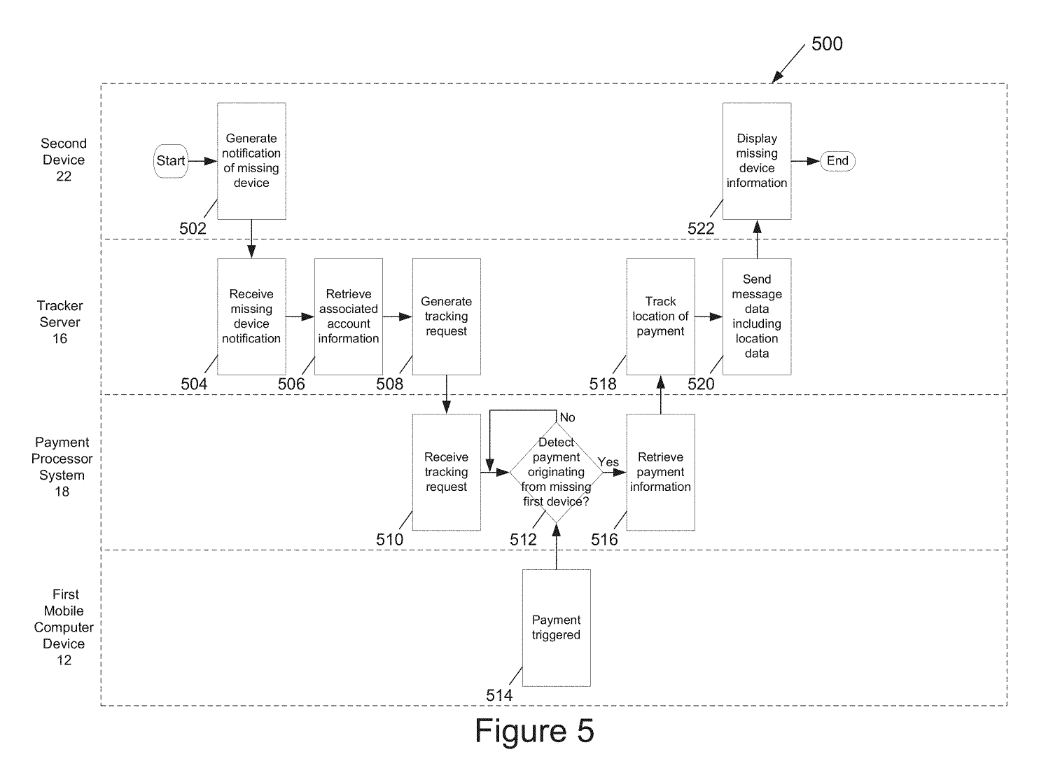

The interoperation of the components of system 10 is hereafter described by way of non-limiting example, with reference to the device tracking process 500 being executed on system 10 as shown in FIG. 5.

A user 14 discovers that his or her mobile computer device 12 is missing and wants to use the tracking account that was set up by process 400 to locate the missing first mobile computer device 12. At step 502 of the device tracking process 500, a user 14 uses a second device 22 to generate a notification that the mobile computer device 12 is missing and needs to be tracked and located. The second device 22 may be a computing device that is network-enabled such as a computer, laptop or mobile computer device capable of communicating with the tracker server 16 using communications network 20. The missing device notification may be generated in a number of ways, including one or more of the following:
(a) a webpage;
(b) an application or software program;
(c) an email; and
(d) a message using a messaging platform e.g. short message system (SMS), iMessage, Whatsapp, LINE.

In another embodiment of the invention, the missing device may be a laptop and as such, the user 14 may use his or her mobile computer device to locate the missing device.

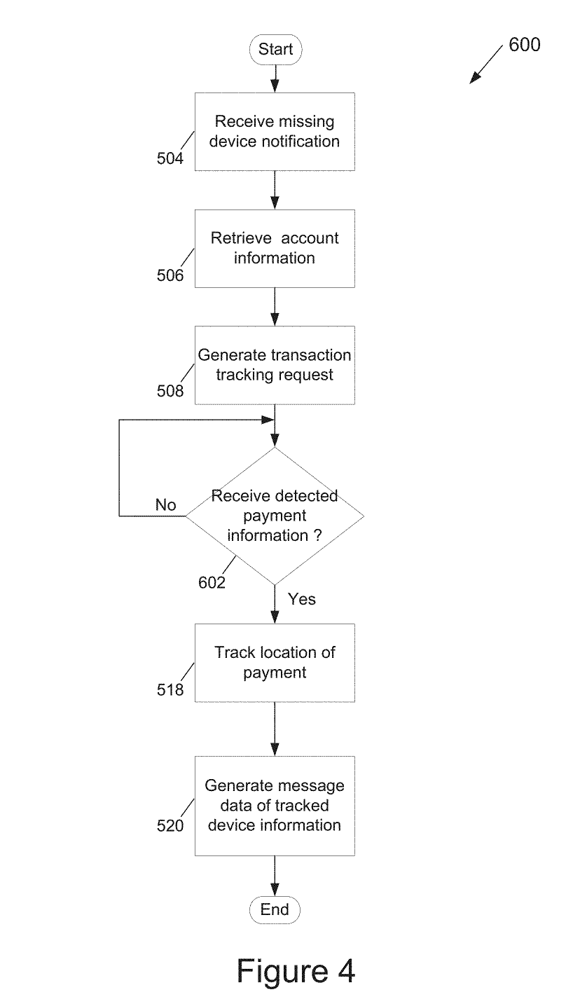

FIG. 4 shows the tracking process 600, a subset of the tracking process 500, showing the steps performed by the tracker server 16.

At step 504, the tracker server 16 receives a notification of a missing device associated to a tracking account. At step 506, the tracker server 16 retrieves account information associated with the missing first mobile computer device 12 from database 316. Account information may comprise user specific information or device specific information.

User specific account information may comprise one or more of the following:
(a) personal information (e.g. full name, address);
(b) device information (e.g. make and model of device, device's connectivity features);
(c) device's payment capabilities (e.g. near field communication (NFC) payment protocols); or
(d) user's payment credentials (e.g. digital wallet account details, payment card information).

Device specific account information associated with the missing first mobile computer device 12 may comprise one or more of the following:
(a) internet protocol (IP) address;
(b) media access control (MAC) address;
(c) global positioning system (GPS) signals;
(d) network communication signals;
(e) subscriber identity module (SIM); and
(f) cellular network.

At step 508, the tracker server 16 generates a request to track missing first mobile computer device 12 and sends the request to the payment processing system 18. The request to track missing first mobile computer device 12 may comprise account information associated with the tracking account as listed above.

At step 510, the payment processing system 18 receives the tracking request. At step 512, the payment processing system 18 generates an alert to detect payments originating from the missing first mobile computer device 12. A payment may be effected at a merchant's point of sale (POS) terminal from the missing first mobile computer device 12 by one or more of the following:
(a) a digital wallet application running on the device; and
(b) a payment card digitized on the device.

A payment may also be an electronic payment including an online payment from one or more of the following:
(a) a webpage;
(b) a mobile application; and
(c) a software program.

Preferably, the alert is sent to the global payment processing network such that any future payments are monitored and detected if they are identified to originate from the missing first mobile computer device 12. The step of monitoring payments originating from the missing first mobile computer device 12 comprises detecting any payment parameters associated with the account information associated with the missing first mobile computer device 12. At step 514, if the missing first mobile computer device 12 is used to initiate a payment, the alert on the payment processing system 18 is triggered and step 516 is performed.

If a payment associated with the missing first mobile computer device 12 is detected, the payment processing system 18 performs step 516 and retrieves associated payment information. If the payment is effected from a merchant's POS terminal, one or more of the following information may be retrieved:
(a) merchant information including one or more of the following:
   (i) name of merchant; and
   (ii) location of transaction; and
(b) information of goods or services purchased including one or more of the following:
   (i) type of goods or services; and
   (ii) transaction cost; and
(c) closed-circuit television (CCTV) surveillance:
   (i) within the merchant's location; and
   (ii) in close proximity to the merchant's location before or after the time the payment was effected at the merchant's POS terminal.

Additional information that may be retrieved from the payment comprises device specific information, including one or more of the following:
(a) an internet protocol (IP) address;
(b) a media access control (MAC) address; and
(c) a device specific address;
(d) global positioning system (GPS) signal;
(e) cell tower's network signals;
(f) subscriber identity module (SIM) based signals;
(g) signals originating from the tracked device; and
(h) network signal e.g. Wi-Fi signal.

The payment processing system 18 retrieves and sends retrieved information to the tracker server 16. At step 602, the retrieved information associated with the detected payment is received by the tracker server 16 and step 518 is performed wherein the location of the payment is tracked. If device specific information is received, tracking of the location may comprise geo-location. This may comprise performing one or more of the following:
(a) tracing an internet protocol (IP) address originating from the tracked device;
(b) tracing a media access control (MAC) address of the tracked device;
(c) tracing a device specific address;
(d) tracing a global positioning system (GPS) signal originating from the tracked device;
(e) multilateration or triangulation of one or more of the following signals:
   (i) cell tower's network signals;
   (ii) subscriber identity module (SIM) based signals;
   (iii) signals originating from the tracked device; and
   (iv) Wi-Fi signal; and
(f) retrieving the location of the merchant.

The location of payment (mobile computer device 12 or merchant) may comprise one or more of the following:
(a) GPS coordinates;
(b) zip code;
(c) city;
(d) state;
(e) region;
(d) country; and
(e) time zone.

At step 520, the tracker server 16 generates message data representing location information and sends it to the user 14. This message data may be one or more of the following:
(a) a telephone call;
(b) a message using a messaging platform e.g. short message system (SMS), iMessage, Whatsapp, LINE; and
(c) an alert on the second device 22.

There are a number of other ways that the mobile computer device 12 may be located. To accommodate these methods, multiple requests may be sent to the relevant entities. Advantageously, the steps follow the requests may be executed concurrently. In another embodiment of the invention, the missing first mobile computer device 12 is tracked by the tracker server 16 using geo-location.

In another embodiment of the invention, the payment processing system 18 may also receive a request from the tracker server 16 to retrieve recent past transactions associated with the identifying data mentioned above. The payment processing system 18, upon receipt of the request, retrieves requested transaction information. The payment processing system 18 then generates message data representing the associated transactions and sends it to the tracker server 16 which is finally sent to the user 14 via the second device. This allows the user 14 to view the transactions and identify any fraudulent transactions. If fraudulent transactions are identified, the user 14 may contact relevant authorities to investigate the origins of the fraud which may assist in locating the missing mobile computer device.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A tracking system, the system including one or more electronic processors, in communication with non-transitory computer readable data storage, which are configured to track a first device by:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with a location of the first device;
(e) determining, at a tracking server, location of the first device; and
(f) sending, to the second device, third message data representing location of the first device to the second device.

2. A tracking system as claimed in claim 1, wherein the first message data representing a tracking request is also sent to one or more of the following:
(a) a third party system; and
(b) the first device.

3. A tracking system as claimed in claim 1, wherein the payment processing system comprises one or more processors configured to, after receiving the second message data:
(a) detect a payment originating from the first device; and
(b) retrieve payment information originating from the first device including one or more of the following:
(i) location associated with the payment information from the first device; and
(ii) merchant information associated with the payment information.

4. A tracking system as claimed in claim 3, wherein the detected payment is triggered by one or more of the following:
(a) a merchant's point of sale terminal; and
(b) an electronic payment.

5. A tracking system as claimed in claim 3, wherein the payment information triggered by the merchant's point of sale terminal comprises one or more of the following:
(a) information relating to a digital wallet account; and
(b) information relating to a payment card digitized on the device.

6. A tracking system as claimed in claim 4, wherein the payment information triggered by the electronic payment comprises an online payment from one or more of the following:
(a) a webpage;
(b) a mobile application; and
(c) a software program.

7. A tracking system as claimed in claim 3, wherein the payment information comprises one or more of the following:
(a) an internet protocol (IP) address;
(b) a media access control (MAC) address;
(c) a device specific address;
(d) global positioning system (GPS) signals;
(e) cell tower network signals;
(f) subscriber identity module (SIM) based signals;
(g) signals transmitted from the first device; and
(h) Wi-Fi signal.

8. A tracking system as claimed in claim 3, wherein the merchant information comprises one or more of the following:
(i) name of merchant; and
(ii) location of transaction.

9. A tracking system as claimed in claim 1, wherein when determining the location of the first device, one or more electronic devices of the tracking server are configured to at least:
(a) trace an internet protocol (IP) address originating from the first device;
(b) trace a media access control (MAC) address of the first device;
(c) trace a device specific address for the first device;
(d) trace a global positioning system (GPS) signal originating from the first device;
(e) multilaterate or triangulate one or more of the following signals:
(i) cell tower network signals;
(ii) subscriber identity module (SIM) based signals;
(iii) signals originating from the first device; and
(iv) Wi-Fi signal; and
(f) determine the location of the merchant.

10. A tracking method, performed by one or more electronic processors in communication with non-transitory computer readable data storage, which are configured to track a first device by:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with location of the first device;
(e) determining, at a tracking server, location of the first device; and
(f) sending, to the second device, third message data representing location of the first device to the second device.

11. A tracking method as claimed in claim 10, wherein the first message data representing a tracking request is also sent to one or more of the following:
(a) a third party system; and
(b) the first device.

12. A tracking method as claimed in claim 10, wherein the payment processing system comprises one or more processors configured to, after receiving the second message data:
(a) detect a payment originating from the first device; and
(b) retrieve payment information originating from the first device including one or more of the following:
(i) location associated with the payment information from the first device; and
(ii) merchant information associated with the payment information.

13. A tracking method as claimed in claim 12, wherein the detected payment is triggered by one or more of the following:
(a) a merchant's point of sale terminal; and
(b) an electronic payment.

14. A tracking method as claimed in claim 12, wherein the payment information triggered by the merchant's point of sale terminal comprises one or more of the following:
(a) information relating to a digital wallet account information; and
(b) information relating to a payment card digitized on the device.

15. A tracking method as claimed in claim 13, wherein the payment information triggered by the electronic payment comprises an online payment from one or more of the following:
(a) a webpage;
(b) a mobile application; and
(c) a software program.

16. A tracking method as claimed in claim 12, wherein the payment information comprises one or more of the following:
(a) an internet protocol (IP) address;
(b) a media access control (MAC) address; and
(c) a device specific address;
(d) global positioning system (GPS) signals;
(e) cell tower's network signals;
(f) subscriber identity module (SIM) based signals;
(g) signals transmitted from the first device; and
(h) Wi-Fi signal.

17. A tracking method as claimed in claim 12, wherein the merchant information comprises one or more of the following:
(i) name of merchant; and
(ii) location of transaction.

18. A tracking method as claimed in claim 10, wherein when determining the location of the first device, one or more electronic devices of the tracking server are configured to at least:
(a) trace an internet protocol (IP) address originating from the first device;
(b) trace a media access control (MAC) address of the first device;
(c) trace a device specific address for the first device;
(d) trace a global positioning system (GPS) signal originating from the first device;
(e) multilaterate or triangulate one or more of the following signals:
(i) cell tower's network signals;
(ii) subscriber identity module (SIM) based signals;
(iii) signals originating from the first device; and
(iv) Wi-Fi signal; and
(f) determine the location of the merchant.

19. A non-transitory computer readable storage medium embodying thereon a program of computer readable instructions which, when executed by one or more processors of a tracking system in communication with a plurality of devices, cause the tracking system to track a first device, the method embodying the steps of:
(a) receiving, from a second device, first message data representing a notification that the first device is missing;
(b) retrieving, from the data storage, account information associated with the first device;
(c) sending, to a payment processing system, second message data representing a tracking request;
(d) receiving, from the payment processing system, information associated with location of the first device;
(e) determining, at a tracking server, location of the first device; and
(f) sending, to the second device, third message data representing location of the first device to the second device.
